(19) United States
(12) Patent Application Publication
(10) Pub. No.: US 2019/0196511 A1
(43) Pub. Date: Jun. 27, 2019

(54) Container Delivery System

(71) Applicant: Walmart Apollo, LLC, Bentonville, AR (US)

(72) Inventors: Andrew B. Millhouse, Gilbert, AZ (US); Jacob R. Schrader, Sterling, IL (US)

(21) Appl. No.: 16/191,360

(22) Filed: Nov. 14, 2018

Related U.S. Application Data
(60) Provisional application No. 62/610,454, filed on Dec. 26, 2017.

(51) Int. Cl. G05D 1/10; B64C 39/02; G01C 21/00

(52) U.S. Cl. CPC G05D 1/101; B64C 39/024; G05D 23/19; B60L 11/1825; G01C 21/005

(57) ABSTRACT

A container delivery system including a container and an unmanned vehicle is described. The container includes an inner chamber configured to receive one or more items. The container including an energy storage device. The unmanned vehicle is configured to deliver the container between a first location and a second location. During delivery of the container by the unmanned vehicle, the unmanned vehicle contacts the container such that the energy storage device provides energy to the unmanned vehicle.

### CROSS-REFERENCE TO RELATED APPLICATIONS

This application claims the benefit of co-pending, commonly assigned U.S. Provisional Patent Application No. 62/610,454, which was filed on Dec. 26, 2017. The entire content of the foregoing provisional patent application is incorporated herein by reference.

### BACKGROUND

Using unmanned vehicles to deliver items provides for alternative options in transporting the items to an intended recipient. Unmanned vehicles generally include a battery which powers the unmanned vehicle during delivery of the item. Exemplary unmanned vehicles include aerial vehicles, such as drones, as well as various types of ground- or water-based vehicles.

### SUMMARY

Exemplary embodiments of the present invention provide container delivery systems including a container with an energy storage device (e.g., a rechargeable battery) and an unmanned vehicle configured to transport the container between different locations. The unmanned vehicle also includes an energy storage device (e.g., a rechargeable battery). When the unmanned vehicle contacts and/or grips the container for initiating transport of the container, the connection between the unmanned vehicle and the container transfers energy from the energy storage device of the container to the energy storage device of the unmanned vehicle. The unmanned vehicle is therefore at least partially recharged as it transports the container, allowing for the unmanned vehicle to travel longer distances than possible on a single battery capacity.

In one embodiment, an exemplary container delivery system is provided. The container delivery system includes a container and an unmanned vehicle (e.g., a drone). The container includes an inner chamber configured to receive one or more items. The container also includes an energy storage device. The unmanned vehicle is configured to deliver the container between a first location (e.g., a loading or packing location) and a second location (e.g., a target delivery destination). During delivery of the container by the unmanned vehicle, the unmanned vehicle contacts the container such that the energy storage device provides energy to the unmanned vehicle (e.g., provides energy to a rechargeable battery of the unmanned vehicle).

In another embodiment, an exemplary locker delivery system is provided. The locker delivery system includes a locker and a drone. The locker includes an inner chamber configured to receive one or more items. The locker also includes a rechargeable battery. The drone is configured to deliver the locker between a first location and a second location. During delivery of the locker by the drone, the drone contacts the rechargeable battery such that the rechargeable battery provides energy to the drone (e.g., provides energy to a rechargeable battery of the drone).

In another embodiment, an exemplary method of container delivery is provided. The method includes providing a container, the container including an inner chamber configured to receive one or more items. The container includes an energy storage device. The method includes coupling an unmanned vehicle to the container to deliver the container between a first location and a second location. During coupling of the unmanned vehicle to the container, the method includes contacting the container with the unmanned vehicle such that the energy storage device provides energy to the unmanned vehicle.

It should be appreciated that other combinations and/or permutations of embodiments are envisioned as also being within the scope of the present invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed container delivery systems and methods, reference is made to the accompanying figures. The accompanying figures, which are incorporated in and constitute a part of this specification, illustrate one or more embodiments of the invention and, together with the description, help to explain the invention. In the figures:

FIG. 1 is a block diagram of an exemplary container delivery system in an embodiment.

FIG. 2A is a diagrammatic top view of a container of an exemplary container delivery system in an embodiment.

FIG. 2B is a diagrammatic cutaway top view of a container of an exemplary container delivery system in an embodiment.

FIG. 3 is a diagrammatic view of an exemplary container delivery system in an embodiment.

FIG. 4 is a block diagram of a computing device in an embodiment.

FIG. 5 is a block diagram of a container delivery system environment in an embodiment.

FIG. 6 is a flowchart illustrating an implementation of a container delivery system in an embodiment.

### DETAILED DESCRIPTION

It should be understood that certain relative terminology used herein, such as, but not necessarily limited to, “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present disclosure. In addition, it should be understood that the scope of the present disclosure is not limited to embodiments having specific dimensions. Thus, any dimensions provided herein are for an exemplary purpose and are not intended to limit the invention to embodiments having particular dimensions.

Unmanned vehicles used for delivery of items are generally limited in travel range by the capacity of the unmanned vehicle battery. Although charging stations can be provided at different locations for recharging the unmanned vehicle battery in-between deliveries, such recharging can be time consuming. In addition, recharging the unmanned vehicle battery in-between deliveries creates a risk that the energy level in the battery may drop during the delivery if the travel distance is beyond a specific range, resulting in missed deliveries and inoperative unmanned vehicles that require additional maintenance/pick-up. Exemplary embodiments of the present invention address these concerns and provide a container delivery system that includes a container with a battery that charges the unmanned vehicle during delivery of the container. More particularly, the exemplary container delivery system includes an unmanned vehicle that contacts the container in such a way that allows for the battery of the unmanned vehicle to receive energy from the battery of the container. Such charging of the unmanned vehicle battery during the delivery ensures that the unmanned vehicle battery will not lose charge, and increases the travel range capabilities of the unmanned vehicle.

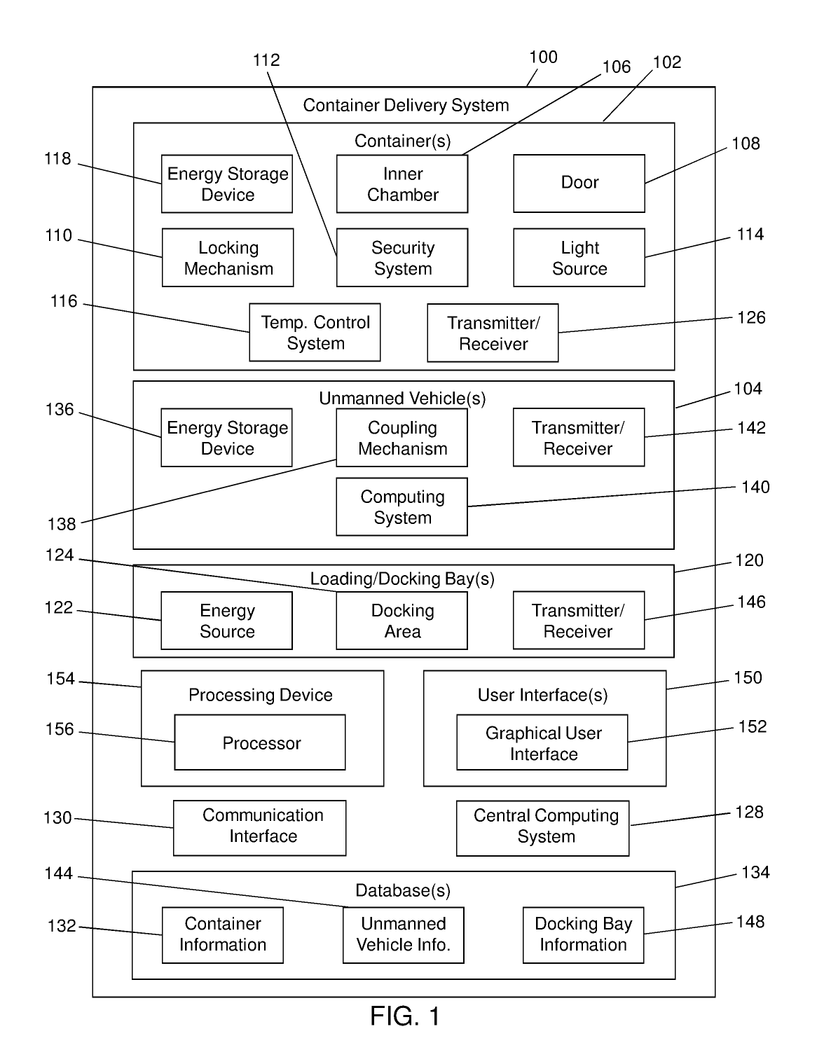

FIG. 1 is a block diagram of a container delivery system 100 (hereinafter “system 100”) in accordance with exemplary embodiments. The system 100 includes one or more containers 102 (e.g., sealable containers, secure lockers, or the like) and one or more unmanned vehicles 104 (e.g., drones, autonomous robotic vehicles, automated guided vehicles, combinations thereof, or the like) for delivering the containers 102 between different locations. For example, the unmanned vehicle 104 can collect one or more containers 102 at a pick-up location (e.g., a first location) and transport/deliver the one or more containers 102 to the same or different drop-off or delivery locations (e.g., second locations).

Each container 102 includes one or more inner chambers 106 configured and dimensioned to securely receive therein one or more items to be delivered by the unmanned vehicle 104. In some embodiments, the container 102 can include multiple, separated inner chambers 106 to maintain separation between certain items to be delivered. The walls separating the inner chambers 106 can be padded and/or insulated. Each container 102 includes an opening or door 108 such that the inner chamber 106 can be accessed for placement or removal of the items into/from the inner chamber 106. Each door 108 can include a locking mechanism 110 (e.g., a lock configured to be opened with a key, biometrics and/or a unique numerical combination input via a keypad). In some embodiments, the container 102 can include a security system 112 configured to detect improper access to the inner chamber 106 after the locking mechanism 110 has been engaged.

The container 102 can include one or more light sources 114 to improve visibility within the inner chamber 106. In some embodiments, a light source 114 can be disposed on an outer surface of the container 102 and can be actuated to emit light when, e.g., the container 102 is ready for pick-up by the unmanned vehicle 104, the container 102 is ready for pick-up at the delivery location, the container 102 is delivered and contains temperature and/or time-sensitive materials, combinations thereof, or the like. In some embodiments, the light source 114 can emit light of different colors depending on the intended visual message.

In some embodiments, the container 102 can include a temperature control system 116 configured to regulate the temperature within the inner chamber 106. In some embodiments, the temperature control system 116 can maintain independent temperature environments in each of the inner chambers 106 depending on the different items being transported. For example, a frozen item can be stored in one inner chamber 106 and a cold environment can be maintained by the temperature control system 116, while a hot item can be stored in another inner chamber 106 in the same container 102 and a hot environment can be maintained by the temperature control system 116.

Each container 102 includes one or more energy storage devices 118 (e.g., rechargeable batteries) providing energy for regulating the temperature control system 116, security system 112, light source 114, locking mechanism 110, combinations thereof, or the like. In some embodiments, the energy storage device 118 can be integrally formed within the body of the container 102. In some embodiments, the energy storage device 118 can be detachably mounted/coupled to the container 102, e.g., the bottom surface of the container 102. During packing of the container 102, the energy storage device 118 can be in contact with a charging element connected to an energy source such that the energy storage device 118 is charged prior to delivery.

In some embodiments, the system 100 can include a loading and/or docking bay 120 at which the containers 102 can be loaded in preparation for delivery. The loading and/or docking bay 120 includes an energy source 122 configured to charge the energy storage device 118 of the container 102. The loading and/or docking bay 120 includes a docking area 124 at which the unmanned vehicles 104 can dock and/or pick-up containers 102 for delivery. Although shown as a single unit, it should be understood that the loading bay and the docking bay can be separate structural units such that containers 102 are loaded at one unit and unmanned vehicles 104 dock at another unit. The system 100 can also include multiple delivery bays (similar to bay 120) at which containers 102 are delivered, such that the energy storage device 118 of empty containers 102 can be charged prior to pick-up by an unmanned vehicle 104.

The container 102 can include a transmitter/receiver 126 configured to electronically (e.g., wirelessly) receive information from a central computing system 128 via a communication interface 130. The transmitter/receiver 126 can electronically transmit information to the central computing system 128 via the communication interface 130 regarding various container information 132 (e.g., a geographic location of each container 102 (as determined via a global positioning system), an energy level of the energy storage device 118, the temperature within each of the inner chambers 106, the locked/unlocked status of the locking mechanism 110, the status of the security system 112, whether the light source 114 is emitting light, combinations thereof, of the like). Such container information 132 can be electronically stored in one or more databases 134 of the system 100. In some embodiments, the transmitter/receiver 126 can communicate directly with the nearest unmanned vehicles 104 regarding whether a pick-up/delivery is needed and/or the energy level of the energy storage device 136.

Each unmanned vehicle 104 includes an energy storage device 136 (e.g., a rechargeable battery) detachably mounted/coupled to the unmanned vehicle 104. The unmanned vehicle 104 includes a coupling mechanism 138 configured to securely latch or grip one or more containers 102 to be delivered by the unmanned vehicle 104. In some embodiments, the coupling mechanism 138 can be in the form of a cage configured to substantially surround the container(s) 102. In some embodiments, the coupling mechanism 138 can be in the form of a housing configured to substantially enclose the container(s) 102. In some embodiments, the coupling mechanism 138 can be in the form of a multi-prong connection (e.g., prongs on the container 102 engaged with complementary openings in the unmanned vehicle 104, prongs on the unmanned vehicle 104 engaged with complementary openings in the container 102, combinations thereof, or the like).

Contact between the unmanned vehicle 104 and the container 102 (e.g., contact between the coupling mechanism 138 and the container 102, contact between the body of the unmanned vehicle 104 and the container 102, or the like) allows the energy storage device 118 of the container 102 to provide energy to the unmanned vehicle 104. In some embodiments, the energy storage device 118 can power the unmanned vehicle 104 directly. In some embodiments, the energy storage device 118 can transfer energy to the energy storage device 136, and the energy storage device 136 can power the unmanned vehicle 104 (e.g., indirect powering of the unmanned vehicle 104).

Thus, upon picking up a container 102 for delivery, contact between the unmanned vehicle 104 and the container 102 provides energy to the unmanned vehicle 104. The unmanned vehicle 104 is therefore capable of traveling longer distances based on the capacity of both energy storage devices 118, 136. Recharging of the energy storage device 136 by the energy storage device 118 further ensures that the unmanned vehicle 104 will not lose energy during delivery.

The unmanned vehicle 104 can include a computing system 140 configured to receive as input, e.g., the weight of a container 102 to be delivered, the delivery location, the delivery route, the energy level of the energy storage device 118, or the like. For example, upon contact with the container 102, the computing system 140 can detect the energy level of the energy storage device 118. Based on such input, the computing system 140 can determine whether the capacity of the energy storage devices 136, 118 will be sufficient to deliver the container 102 and whether additional charging of the energy storage devices 136, 118 is needed (e.g., it may determine a delivery radius range).

Based on the total weight of the containers 102 to be delivered, the central computing system 128 can determine an appropriately sized unmanned vehicle 104 and can request arrival of such unmanned vehicle 104 to the location of the container 102. For example, if multiple containers 102 or containers 102 having a total weight above a predetermined threshold are in need of delivery, the central computing system 128 can select a larger unmanned vehicle 104 for such delivery, while a smaller unmanned vehicle 104 can be used to deliver a light container 102. The unmanned vehicle 104 can include a transmitter/receiver 142 configured to electronically (e.g., wirelessly) receive information from the central computing system 128 and/or the containers 102 via the communication interface 130.

The transmitter/receiver 142 can electronically transmit information to the central computing system 128 and/or the containers 102 via the communication interface 130 regarding various unmanned vehicle information 144 (e.g., a geographic location of each unmanned vehicle 104 (as determined via a global positioning system), an energy level of the energy storage device 136, combinations thereof, of the like). Such unmanned vehicle information 144 can be electronically stored in one or more databases 134 of the system 100. The unmanned vehicles 104 can therefore be in communication with the central computing system 128 and the containers 102 to determine whether additional pick-up/delivery of containers 102 is needed and to determine the nearest container 102 locations if additional charging is needed for the unmanned vehicle 104.

In-between deliveries, the unmanned vehicle 104 can dock at the docking area 124 of the loading and/or docking bay 120, and the energy storage device 136 can be recharged by the energy source 122. In some embodiments, docking bay 120 can be located at both pick-up and delivery locations such that the energy storage device 136 can be recharged after delivery of the container 102 has been made. In some embodiments, the containers 102 and/or the unmanned vehicles 104 can include solar panels configured to charge the energy storage devices 118, 136 during transport of the container 102. In some embodiments, the bay 120 can include solar panels as the energy source 122. The loading and/or docking bay 120 can include a transmitter/receiver 146 configured to electronically (e.g., wirelessly) receive and/or transmit information from/to the central computing system 128, the containers 102 and/or the unmanned vehicles 104 via the communication interface 130.

The docking bay information 148 transmitted from the loading and/or docking bay 120 can include, e.g., a geographic location of the bay 120, the number of containers 102 for pick-up at the bay 120 (and the energy level of each container 102), the number of unmanned vehicles 104 at the bay 120 (and the energy level of each unmanned vehicle 104), combinations thereof, or the like. The docking bay information 148 can be electronically stored in one or more databases 134 of the system 100.

The system 100 can include one or more user interfaces 150 having a graphical user interface (GUI) 152 for receiving input and/or displaying information to a user. Although shown as a separate component of the system 100, it should be understood that the containers 102, the unmanned vehicles 104 and/or the loading/docking bays 120 can each include one or more user interfaces 150 for displaying data, information or notifications about the containers 102, the unmanned vehicles 104 and/or the loading/docking bays 120. The system 100 can include one or more processing devices 154 having one or more processors 156 for processing the data received by the central computing system 128 and stored in the databases 134.

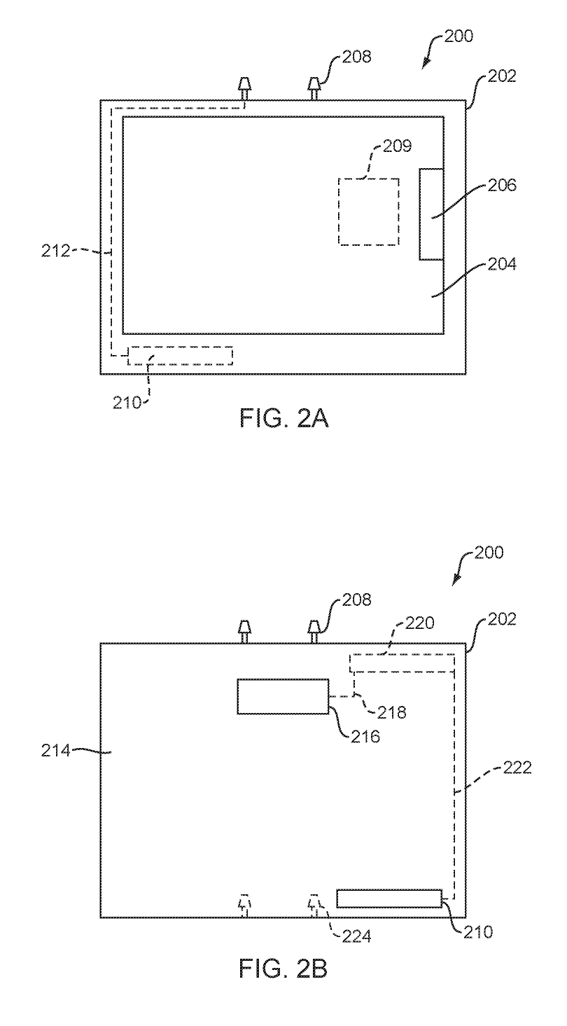

FIG. 2A is a diagrammatic front view of an exemplary container 200 of the system 100 in accordance with exemplary embodiments. The container 200 includes a body 202 configured to securely enclose one or more items to be delivered. The container 200 includes a door 204 movably connected to the body 202, and a locking mechanism 206 for maintaining the door 204 locked to the body 202. In some embodiments, the container 200 can include a user interface 209 (e.g., a display, a keypad, combinations thereof, or the like) that provides notifications to the user and allows the user to input data, such as a code to unlock the locking mechanism 206. In one embodiment, the container 200 may include an interface to accept biometric data in the form of a fingerprint to control locking mechanism 206. In some embodiments, the container 200 can include a coupling mechanism 208 configured to engage and detachably couple with the coupling mechanism 138 of the unmanned vehicle 104. The coupling mechanism 208 can be in the form of, but is not limited to, two or more prongs protruding from the body 202.

Such prongs can be received and locked by complementary openings in the coupling mechanism 138 of the unmanned vehicle 104, such that the container 200 can remain structurally connected to the unmanned vehicle 104 until delivery has been made. The container 200 includes an energy storage device 210, such as, but not limited to a rechargeable battery that is electrically connected via, e.g., wires 212, to the coupling mechanism 208. Upon engagement of the coupling mechanisms 138, 208, the energy storage device 210 can transfer energy to the energy storage device 136 of the unmanned vehicle 104 to increase the overall travel range of the unmanned vehicle 104. In some embodiments, the coupling mechanism 138 can be used to connect the container 200 to an energy source (e.g., the energy source 122 of the bay 120) to recharge the energy storage device 210.

FIG. 2B is a diagrammatic cutaway top view of the container 200 of FIG. 2A. The container 200 includes an inner chamber 214 and a temperature control system 216 for regulating the temperature within the inner chamber 214. In some embodiments, the temperature control system 216 can be in the form of a hot/cold plate. The temperature control system 216 can be electrically connected via, e.g., wires 218, to a controller 220. The controller 220 can be part of the transmitter/receiver 126 or can be a separate component of the container 200.

The controller 220 can be in communication with the central computing system 128 via the transmitter/receiver 126 such that data regarding the desired temperature for the inner chamber 214 can be received by the controller 220 to appropriately regulate the temperature control system 216. The energy storage device 210 can be electrically connected via, e.g., wires 222, to the controller 220 to provide power to the temperature control system 216 and the controller 220.

In some embodiments, the container 200 can include a docking section 224 formed within the body 202. The docking section 224 can be in the form of two or more openings complementary to prongs of, e.g., the coupling mechanism 138 of the unmanned vehicle 104, a docking station of the bay 120 for charging the energy storage device 210, or the like. The energy storage device 210 can be electrically connected to the docking section 224 to allow for charging of the energy storage device 210.

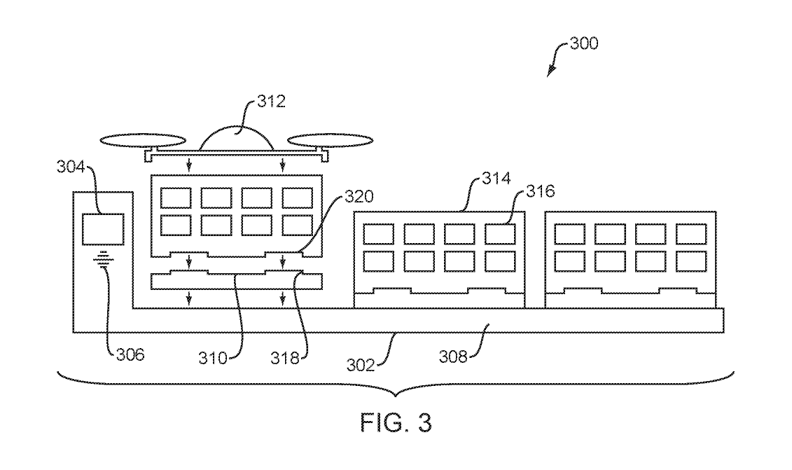

FIG. 3 is a diagrammatic view of an exemplary container delivery system 300 (hereinafter “system 300”). The system 300 includes a loading/docking bay 302 with a user interface 304 (e.g., a touchscreen panel) and speaker 306 for outputting notifications to the user. The bay 302 includes a charging section 308 configured to receive and charge one or more energy storage devices 310 such as rechargeable batteries (e.g., extended batteries) for either an unmanned vehicle 312 or a container 314.

Each container 314 can receive one or more items 316 to be delivered. The energy storage device 310 includes an interface 318 for engagement with the container 314 such that the energy storage device 310 can provide power to systems of the container 314 and the unmanned vehicle 312 during delivery. The container 314 also includes an interface 320 complementary to the interface 318 to allow for engagement between the energy storage device 310 and the container 314.

Thus, in operation, orders for items can be placed remotely by a customer. One or more containers 314 are prepared with the items 316 to be delivered based on the order and, once complete, the containers 314 can be loaded on the bay 302. Each container 314 is connected to a respective energy storage device 310 to power components of the container 314. Upon reaching a predetermined energy level of the energy storage device 310, the unmanned vehicle 312 engages with the container 314 and transports the container 314 to the delivery location. During engagement between the unmanned vehicle 312 and the container 314, the energy storage device 310 provides energy to the battery of the unmanned vehicle 312.

In some embodiments, delivery of the container 314 can be made to a delivery bay (similar to bay 302) that allows for charging of the energy storage device 310 prior to pick-up of the empty container 314 for transport back to the bay 302. After delivery of the container 314 has been made, the unmanned vehicle 312 can determine which of the empty containers 314 at the delivery bay has been there the longest. The unmanned vehicle 312 can engage with the selected empty container 314 (with the charged energy storage device 310) and transports the empty container 314 to the bay 302 for additional deliveries.

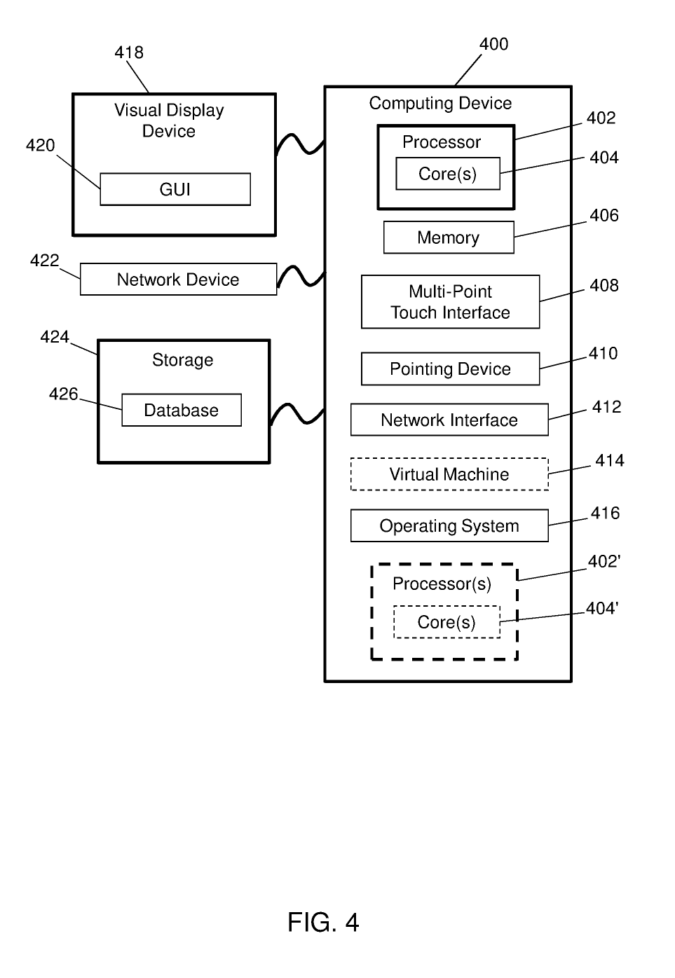

FIG. 4 is a block diagram of a computing device 400 in accordance with exemplary embodiments. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 406 included in the computing device 400 may store computer-readable and computer-executable instructions or software for implementing exemplary embodiments of the present disclosure (e.g., instructions for controlling components of the container 102, the unmanned vehicle 104, the loading/docking bay 120, the processing device 154, the user interfaces 150, the communication interface 130, the central computing system 128, combinations thereof, or the like). The computing device 400 also includes configurable and/or programmable processor 402 and associated core 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ may each be a single core processor or multiple core (404 and 404′) processor.

Virtualization may be employed in the computing device 400 so that infrastructure and resources in the computing device 400 may be shared dynamically. A virtual machine 414 may be provided to handle a process running on multiple processors so that the process appears to be using only one computing resource rather than multiple computing resources. Multiple virtual machines may also be used with one processor. Memory 406 may include a computer system memory or random access memory, such as DRAM, SRAM, EDO RAM, and the like. Memory 406 may include other types of memory as well, or combinations thereof.

A user may interact with the computing device 400 through a visual display device 418 (e.g., a personal computer, a mobile smart device, or the like), such as a computer monitor, which may display one or more user interfaces 420 (e.g., GUI 152) that may be provided in accordance with exemplary embodiments. The computing device 400 may include other I/O devices for receiving input from a user, for example, a keyboard or any suitable multi-point touch interface 408, a pointing device 410 (e.g., a mouse). The keyboard 408 and the pointing device 410 may be coupled to the visual display device 418. The computing device 400 may include other suitable conventional I/O peripherals.

The computing device 400 may also include one or more storage devices 424, such as a hard-drive, CD-ROM, or other computer readable media, for storing data and computer-readable instructions and/or software that implement one or more portions of the system 100, such as the container 102, the unmanned vehicle 104, the loading/docking bay 120, the processing device 154, the user interfaces 150, the communication interface 130, the central computing system 128, or the like. Exemplary storage device 424 may also store one or more databases 426 for storing any suitable information required to implement exemplary embodiments. For example, exemplary storage device 424 can store one or more databases 426 for storing information, such as data relating to the container information 132, the unmanned vehicle information 144, the docking bay information 148, or the like, and computer-readable instructions and/or software that implement exemplary embodiments described herein. The databases 426 may be updated by manually or automatically at any suitable time to add, delete, and/or update one or more items in the databases.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 may include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 400 may run an operating system 416, such as versions of the Microsoft® Windows® operating systems, the different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 416 may be run in native mode or emulated mode. In an exemplary embodiment, the operating system 416 may be run on one or more cloud machine instances.

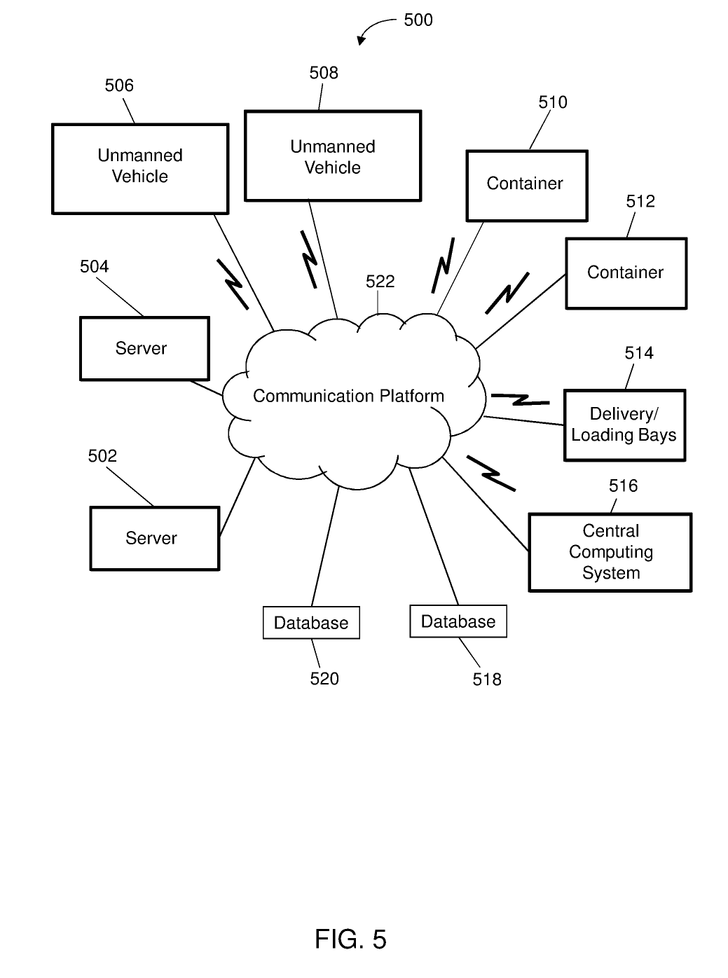

FIG. 5 is a block diagram of an exemplary container delivery system environment 500 in accordance with exemplary embodiments of the present disclosure. The environment 500 can include servers 502, 504 operatively coupled to unmanned vehicles 506, 508, containers 510, 512, delivery/loading bays 514, and central computing system 516, via a communication platform 522, which can be any network over which information can be transmitted between devices communicatively coupled to the network. For example, the communication platform 522 can be the Internet, Intranet, virtual private network (VPN), wide area network (WAN), local area network (LAN), and the like. In an embodiment, the communication platform 522 can be part of a cloud environment.

The environment 500 can include repositories or databases 518, 520, which can be operatively coupled to the servers 502, 504, as well as to the unmanned vehicles 506, 508, the containers 510, 512, the delivery/loading bays 514, and the central computing system 516, via the communications platform 522. In exemplary embodiments, the servers 502, 504, unmanned vehicles 506, 508, the containers 510, 512, the delivery/loading bays 514, and the central computing system 516, and databases 518, 520 can be implemented as computing devices (e.g., computing device 400). Those skilled in the art will recognize that the databases 518, 520 can be incorporated into one or more of the servers 502, 504 such that one or more of the servers 502, 504 can include databases 518, 520.

In an embodiment, the databases 518, 520 can store container information, the unmanned vehicle information, and the docking/delivery bay information. In an embodiment, embodiments of the servers 502, 504 can be configured to implement one or more portions of the system 100. For example, server 502 can be configured to implement one or more portions of the unmanned vehicles 506, 508, the containers 510, 512, the delivery/loading bays 514, and/or the central computing system 516.

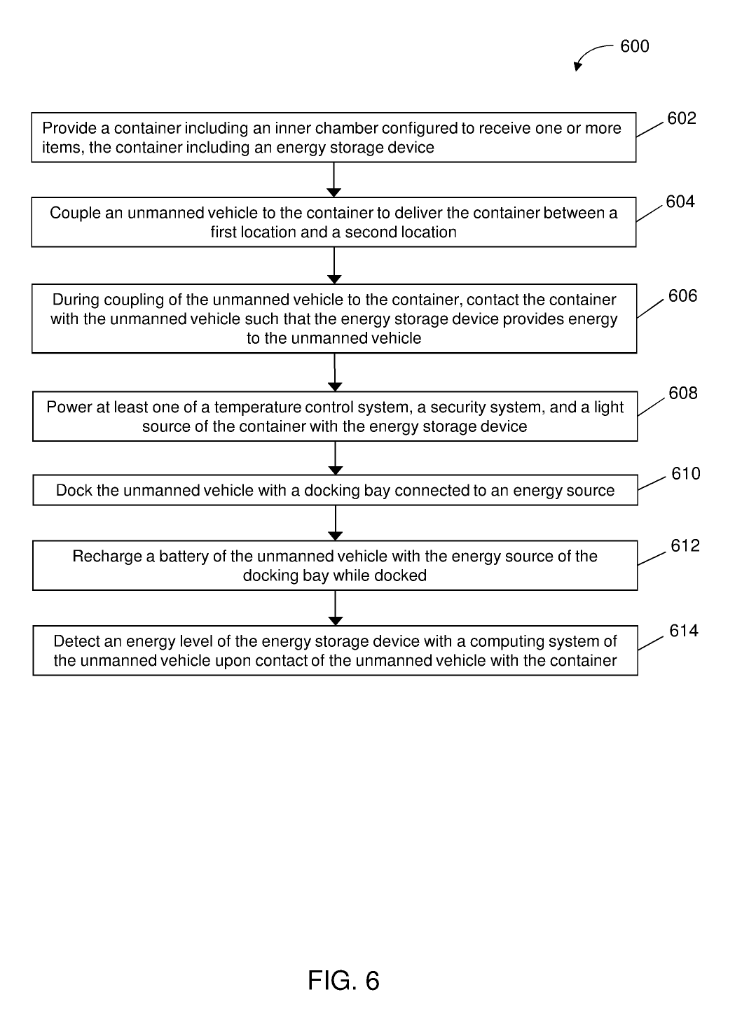

FIG. 6 is a flowchart illustrating an exemplary process 600 as implemented by a container delivery system. To begin, at step 602, a container including an inner chamber configured to receive one or more items, and including an energy storage device, is provided. At step 604, an unmanned vehicle is coupled to the container to deliver the container between first and second locations. At step 606, during coupling of the unmanned vehicle to the container, the container is contacted with the unmanned vehicle such that the energy storage device of the container provides energy or power to the unmanned vehicle (e.g., the battery of the unmanned vehicle).

At step 608, the temperature control system, the security system, and/or the light source of the container can be powered with the energy storage device. The energy storage device of the container thereby provides energy to both the container and the unmanned vehicle. At step 610, the unmanned vehicle can be docked with a docking bay connected to an energy source. At step 612, an energy storage device such as a battery of the unmanned vehicle can be recharged with the energy source while the unmanned vehicle is docked with the docking bay. At step 614, an energy level of the energy storage device of the container can be detected by the unmanned vehicle upon contact of the unmanned vehicle with the container. Such detection can be used when delivering a container and/or when determining whether a container is fully charged for transport between bays.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A container delivery system, comprising:
a container including an inner chamber configured to receive one or more items, the container including an energy storage device; and
an unmanned vehicle configured to deliver the container between a first location and a second location;
wherein during delivery of the container by the unmanned vehicle, the unmanned vehicle contacts the container such that the energy storage device provides energy to the unmanned vehicle.

2. The container delivery system of claim 1, wherein the container is a locker including a door and a locking mechanism for locking the door.

3. The container delivery system of claim 1, wherein the container includes at least one of a temperature control system for regulating a temperature within the inner chamber, a security system, and a light source.

4. The container delivery system of claim 3, wherein the energy storage device provides energy for regulating at least one of the temperature control system, the security system, and the light source.

5. The container delivery system of claim 1, wherein the energy storage device is a battery detachably coupled to the container.

6. The container delivery system of claim 1, wherein the unmanned vehicle is one of a drone, autonomous robotic vehicle, and automated guided vehicle.

7. The container delivery system of claim 1, wherein during delivery of the container by the unmanned vehicle, the energy storage device recharges a battery of the unmanned vehicle.

8. The container delivery system of claim 1, further comprising
a docking bay located at least one of the first location and second location, the docking bay connected to an energy source.

9. The container delivery system of claim 8, wherein the unmanned vehicle is configured to dock with the docking bay, the energy source of the docking bay recharging a battery of the unmanned vehicle while docked.

10. The container delivery system of claim 8, wherein the docking bay includes a user interface configured to display data corresponding to the docked unmanned vehicle.

11. The container delivery system of claim 1, wherein upon contact of the unmanned vehicle with the container, a computing system of the unmanned vehicle detects an energy level of the energy storage device and, based on the detected energy level, the computing system determines whether recharging of the energy storage device is needed.

12. The container delivery system of claim 1, comprising a central computing system in communication with the unmanned vehicle and the container.

13. The container delivery system of claim 12, wherein the central computing system maintains data corresponding to at least one of a geographic location of the unmanned vehicle, a geographic location of the container, an energy level of the energy storage device of the container, and an energy level of an energy storage device of the unmanned vehicle.

14. A locker delivery system, comprising:
a locker including an inner chamber configured to receive one or more items, the locker including a rechargeable battery; and
a drone configured to deliver the locker between a first location and a second location;
wherein during delivery of the locker by the drone, the drone contacts the rechargeable battery such that the rechargeable battery provides energy to the drone.

15. The locker delivery system of claim 14, wherein the locker includes at least one of a temperature control system for regulating a temperature within the inner chamber, a security system, and a light source.

16. The locker delivery system of claim 15, wherein the rechargeable battery provides energy for regulating at least one of the temperature control system, the security system, and the light source.

17. A method of container delivery, comprising:
providing a container including an inner chamber configured to receive one or more items, the container including an energy storage device;
coupling an unmanned vehicle to the container to deliver the container between a first location and a second location; and
during coupling of the unmanned vehicle to the container, contacting the container with the unmanned vehicle such that the energy storage device provides energy to the unmanned vehicle.

18. The method of claim 17, further comprising:
powering at least one of a temperature control system, a security system, and a light source of the container with the energy storage device.

19. The method of claim 17, further comprising:
docking the unmanned vehicle with a docking bay connected to an energy source, and recharging a battery of the unmanned vehicle with the energy source while docked.

20. The method of claim 17, further comprising:
detecting an energy level of the energy storage device with a computing system of the unmanned vehicle upon contact of the unmanned vehicle with the container.
